(19) United States
(12) Patent Application Publication
(10) Pub. No.: US 2007/0220105 A1
(43) Pub. Date: Sep. 20, 2007

(54) Methods and System for Enhanced Prior Art Search Techniques

(75) Inventors: Andrew S. Van Luchene, Santa Fe, NM (US); Raymond J. Mueller, Palm Beach Gardens, FL (US); Dean Alderucci, Westport, CT (US)

Correspondence Address: GONZALES PATENT SERVICES, 4605 CONGRESS AVE. NW, ALBUQUERQUE, NM, 87114, US

(73) Assignee: LEVIATHAN ENTERTAINMENT, LLC, Santa Fe, NM (US)

(21) Appl. No.: 11/696,073

(22) Filed: Apr. 3, 2007

Related U.S. Application Data
(63) Continuation-in-part of application No. 11/462,621, filed on Aug. 4, 2006.
(60) Provisional application No. 60/727,191, filed on Oct. 14, 2005.

(51) Int. Cl. G06F 15/16

(52) U.S. Cl. 709/217

(57) ABSTRACT

The present disclosure provides various novel means for performing prior art searches for patent applications. The disclosure describes various automated means for performing and refining prior art searches with decreasing examiner input and generating office actions based on such searches.

### PRIORITY CLAIM

The following application is a continuation-in-part of U.S. patent application Ser. No. 11/462,621, filed Aug. 4, 2006, which claims the benefit of U.S. Provisional Patent Application Ser. No. 60/727,191, “Methods and Systems to Improve the Patent Filing and Issuance Process” filed Oct. 14, 2005. Each of which is hereby incorporated by reference.

### BACKGROUND

Protecting intellectual property through patent systems is a vital part of most countries' national economies and well as the global economy. However, many known patent systems are facing a number of challenges due to the increased technical complexity of patent applications coupled with the challenge of hiring and training new patent examiners to cope with the increasing number of applications being filed.

Patent application filings have been monotonically increasing since 1995. In 2000, 311,807 patent applications were filed in the U.S. This number increased to 409,532 applications in 2005. Globally, 145,300 applications were filed under the Patent Cooperation Treaty in 2006, representing a 6.4% growth over the previous year.

The increasing number of applications being filed further exacerbates the burden of examination placed on patent systems and examiners. Each application filed becomes prior art against later applications; the growth in the number of applications filed as well as the proliferation of the amount of prior art and generally available information increases the difficulty and time required to perform accurate and efficient searches of the prior art to determine the novelty of an invention.

The problems in the protection of intellectual property rights are further compounded by virtual reality games. Hundreds of thousands of players access games known as massive multi-player online games (MMOGs) and massive multi-player online role playing games (MMORPGs). Players of these games customarily access a game repeatedly (for durations typically ranging from a few minutes to several days) over a given period of time, which may be days, weeks, months or even years. Many of these games purport to give intellectual property rights to the players in their virtual creations. However, these games lack a structured system for evaluating and granting such rights. Additionally the creations themselves become prior art for which there are no accurate methods of searching and analyzing.

It usually takes years of training to fully develop the skills required to ascertain a proper search strategy after analyzing an application, particularly in areas of emerging technologies where most if not all art is in non-patent literature sources. Given the increasing number of applications being filed and the increased demand for protection of intellectual property, it would be advantageous to provide alternate methods for performing prior art searches.

### BRIEF DESCRIPTION OF THE DRAWINGS

FIG. 1 is a block diagram depicting a system 100 of an embodiment of the present invention.

FIG. 2 is a block diagram depicting a system 200 of an embodiment of the present invention.

### DETAILED DESCRIPTION

A patent is a means for protecting the rights of an inventor. It is a property right granted to an inventor by a governing entity or by a regional office or other third party acting for a governing entity or group of government entities. This right allows the inventor to exclude anyone else from commercially exploiting the inventor's invention for a set time period. What is granted is not the right to make, use, offer for sale, sell or import, but the right to exclude others from making, using, offering for sale, selling or importing the invention.

By granting an exclusive right patents provide incentives to individuals, offering them recognition for their creativity and material reward for their marketable inventions. These incentives encourage innovation. Due to the steady increase in the number of applications being filed, the burden on various patent offices has increased. This increase has resulted in delays in reviewing applications and increased workloads for examiners. There have been many efforts to streamline the patent application process, shorten examination times and ensure the quality of issued patents. However, the sheer number of applications submitted can be overwhelming.

Various embodiments of the present invention address this issue by providing methods and systems for performing prior art searches. Prior art searches are time consuming and speeialized, but do not necessarily require intimate knowledge of patent law or patent office procedures. Systems may therefore be developed for automating such procedures, freeing both real and virtual examiners to do the examination and more qualitative analyses of the applications.

According to various embodiments:

Abstract of the Invention—includes that part of a patent application that is the abstract as defined by the USPTO guidelines.

Agent—includes the agent responsible for filing a patent application.

Alternate Language—includes words that can be used as alternates for words in a patent application.

Artificial Intelligence—includes any computer program that uses neural nets and genetic algorithms.

Assignee Name—includes the meaning defined by the USPTO guidelines.

Assignee City—includes the meaning defined by the USPTO guidelines.

Assignee State—includes the meaning defined by the USPTO guidelines.

Assignee Country—includes the meaning defined by the USPTO guidelines.

Attorney—includes the attorney responsible for drafting and/or filing a patent application.

Attorney Name—includes the meaning defined by the USPTO guidelines.

Attorney Address—includes the meaning defined by the USPTO guidelines.

Attorney State—includes the meaning defined by the USPTO guidelines.

Attorney Country—includes the meaning defined by the USPTO guidelines.

Background of the Invention—includes that part of a patent application that is background as defined by the USPTO guidelines.

Claims—includes that part of a patent application that is claims as defined by the USPTO guidelines.

Date Stamp—includes an electronic, unalterable stamp on an electronic file indicated the date that the file was created or received by a computer system.

Date of Invention—includes the date a patent application has with a first time stamp.

Degree of infringement—includes the statistically measured amount that a product or technical white paper infringes an issued patent application.

Description of the Invention—includes that part of a patent application that is description as defined by the USPTO guidelines.

Draftsperson—includes the meaning defined by the USPTO guidelines.

Dollar Value—includes a dollar amount that is defined as the value of a patent license of a patent.

End User—includes any user of a system including an inventor, researcher, attorney, or agent who is interacts wiuth the system, e.g., by creating, enhancing, researching, filing, prosecuting, licensing, or invalidating a patent application. An end user may be required to be a member of a central system.

Electronic notification—includes an email or other means of digitally sending a message with a date and time stamp to an electronic address.

Errors and Omissions—includes the meaning defined by the USPTO guidelines

Examiner—includes a patent examiner.

Issued Patent—includes the meaning defined by the USPTO guidelines.

Filing Date—includes the time stamp of the date that a patent application was submitted to the patent office.

Filed Patent—includes a patent application that is filed with the USPTO.

File Wrapper—includes all files associated with a patent application including but not limited to: the patent application, a certified search, notes of distinguishing language, notes of rejection, notes of additional distinguishing language, record of interview, additional prior art references, and all electronic notifications associated with a patent application.

First Office Action—includes the meaning described in the USPTO guidelines.

Genetic Algorithm—includes a computer algorithm that is capable of modifying and improving itself over time.

Infringement—includes that a product or technical white paper practices the invention protected by the claims of an issued patent.

Interview—includes an electronically recorded conversation between an end user and a patent examiner.

Invention Class—includes the meaning described in the USPTO guidelines.

Invention Subclass—includes the meaning described in the USPTO guidelines.

Invention Figures—includes the meaning described in the USPTO guidelines.

Invention Claims—includes the meaning described in the USPTO guidelines.

Inventor Name—includes the meaning described in the USPTO guidelines.

Inventor City—includes the meaning described in the USPTO guidelines.

Inventor State—includes the meaning described in the USPTO guidelines.

Inventor Country—includes the meaning described in the USPTO guidelines.

Issued Patent—includes the meaning described in the USPTO guidelines.

Literature Prior Art—includes prior art for a patent application other than patents.

Missing Parts—includes the meaning described in the USPTO guidelines.

Non-Obviousness Score—includes a score given to a patent application by a central system that relates the obviousness of the invention disclosed by the patent application to prior art cited by the central system.

Notice of allowance—includes the meaning defined by the USPTO guidelines.

Notes—includes any language added to a prior art record by an end user.

Note of distinguishing language—includes notes provided by end users in response to the prior art cited in a certified search. These notes distinguish a patent application submitted by the end user over the prior art references contained in the certified search provided by the central system.

Note of additional distinguishing language—includes notes provided by end users in response to a second office action conducted by a patent examiner.

Note of rejection—includes the notes contained in a second office action provided by a patent examiner.

Novel—includes the meaning described in the USPTO guidelines.

Novelty Score—includes a score given to a patent application by a central system that related the novelty of the invention disclosed in the patent application to prior art cited by the central system.

Obvious—includes the meaning described in the USPTO guidelines.

Office Action—includes the meaning described in the USPTO guidelines.

Online Chat Room—includes any electronic correspondence medium that allows for a real time, electronic conversation between a patent examiner and an end user.

Patent Application—includes any document created to describe and invention by an end user.

Patent Application Data—includes data contained in a patent application.

Patent Application Date—includes the time stamped date that a patent application was entered into a central system.

Patent Examiner—includes a person responsible for reviewing the patent application and deciding if the patent can be issued.

Patent examination queue—includes the queue of patent applications that are assigned to a patent examiner that require office actions or reexaminations.

Patent invalidator—includes an end user who is attempting to invalidate an issued patent.

Patent License—includes a legal right to use an invention disclosed in an issued patent.

Patent Licensee—includes an end user who is licensing an issued patent.

Patent Office—includes the United State Patent and Trademark Office and any other Intellectual Property authority, virtual or real in this or any other world.

Patent Prior Art—includes prior art that is filed and issued patents.

Patent Value score—includes a score assigned by an artificial intelligence system that demonstrates the strength of the claims of an issued patent in light of prior art.

PCT Information—includes the meaning described in the USPTO guidelines.

Potential Licensee—includes an end user who may want to license an issued patent.

Prior Art—includes any document with a time stamp prior to the time stamp of a patent application.

Prior Art Data—includes data that is prior art.

Priority Date—includes the meaning described in the USPTO guidelines.

Product—includes a created thing that can be protected by or that can infringe the claims of an issued patent.

Published Prior Art—includes prior art that is available for review by the general public.

Reexamination—includes a second examination of a patent after it has been issued.

Relevance Score—includes a score assigned by an end user or by a central system to a particular piece of prior art as it relates to a particular patent application.

Research Report—includes a report assemble by a researcher or a central system that contains prior art related to a patent application.

Researcher—includes a person who manually researches prior art databases to find prior art related to a patent application.

Score—includes a numerical value assigned to something as it relates to something else.

Second Office Action—includes the meaning described in the USPTO guidelines.

Second examination—includes reexamination.

Status Change—includes a change in status of a patent application as it moves through the patent process. Changes in status can include but are not limited submitting the application for examination, receiving a certified search for the application, placing the patent application in an examiner queue, receiving an office action for the patent application, receiving a notice of allowance for the patent application, receiving a notice of missing parts for the patent application; receiving a patent number for the patent application, and receiving an indication of interest from a potential licensee for the patent application.

Submitted Patent Application—includes a patent application that an end user submits to the central system for examination.

Subsequent Patent Application—includes an application that comes after a patent application.

Technical white paper—includes a text description of a product that describes the parts of the product and how they work together.

Time Stamp—includes an unalterable recording of the time a document was created by, entered into, or received by a system.

Title—includes the meaning described in the USPTO guidelines.

Web-Based Application—includes an application that is accessible on the World Wide Web via a web browser such as Microsoft's Internet Explorer. The application will be stored on a central server and accessed via other computers.

Web-Based Form—includes an electronic form used to enter information by and end user into a web-based application.

Unpublished Prior Art—includes prior art that is not available to the general public, but that can be viewed by employees of the central system.

Useful—includes the meaning described in the USPTO guidelines.

Usefulness Score—includes a score given to a patent application based on its usefulness as defined by the USPTO guidelines.

Generally, after a patent application is received by a patent office or other examining entity, it is assigned to a technology center, art group, or other subsection of the receiving office which specializes on the particular field of the invention. The application is then more specifically classified and assigned to an Examiner by a senior examiner or other reviewing entity. The Examiner plans a search by identifying the field of search, selecting the tool(s) to perform the search and determining the appropriate search strategy. The field of search includes local and international patents and patent applications as well as nonpatent literature. Given the increasing number of applications as well as the increasing amount of prior art available for searching, it would be advantageous to decrease the amount of examiner time required to perform a search allowing examiners to concentrate on patentability determinations rather than spending a significant amount of time searching.

According to an embodiment of the present disclosure, when a new application is submitted to a patent office or other receiving office for examination, a profile may be generated taking into consideration the field of invention, class, subclass, abstract, claims, inventorship, any additional relevant information or any combination thereof. Such a review may be manual or automated. In some embodiments, a review may be run using a simple table based method, quantitative and qualitative approaches to decision analysis, a rules based system, or artificial intelligence techniques, for example neural net, Bayesian algorithm, genetic algorithms, pattern recognition, expert systems, case based reasoning, fuzzy systems, hybrid intelligent systems, evolutionary computation, concept processing or any combination thereof.

The review may generate a score for the application which may be used in determining a search strategy. Scores may include factors such as the subject matter of the invention, the class, the area of technology, the newness of the technology, the art cited in the application, the art cited in any parent application, art submitted in an information disclosure statement, other applications filed by the inventor(s), publications by the inventor(s), citations in the publications of the inventor(s), art in other applications filed by the inventor(s), key words in the application, field of the application, any other relevant material, or any combination or subset thereof.

The score of the application may then be compared to the scores of other applications, or to the scores of databases available for searching. In some embodiments, the search strategy or file wrappers for similar applications or applications in the same art may be reviewed to determine appropriate databases or search strategies.

Once a search strategy has been composed, it may be run in any of a number of databases including databases containing patent documents, foreign patent documents and non-patent literature. Profiles of databases may be determined based on any of a number of criteria such as the field of a particular database, the appropriateness of particular databases, the contents of particular databases, the accuracy of particular databases, how current particular databases are, the number of times other examiners have used particular databases, the breadth of a particular database, the focus of a particular database, the ease of use of a particular database or any combination thereof. Databases may be selected manually or using automated means. In some embodiments, numeric scores for databases may be calculated using simple table based methods, quantitative and qualitative approaches to decision analysis, a rules based system, or artificial intelligence techniques, for example neural net, Bayesian algorithm, genetic algorithms, pattern recognition, expert systems, case based reasoning, fuzzy systems, hybrid intelligent systems, evolutionary computation, concept processing or any combination thereof. Such scores may be relevance scores, or scores for other purposes.

In some embodiments, particular databases may be more appropriate for particular fields of art. For example, in certain fields, most of the inventions may be modifications on prior patented inventions and therefore searches may be limited to patent databases. In other fields, there may be relatively few existing patents and therefore searches may be performed in databases that include non-patent literature. Some of these databases may focus on particular areas of technology, for example, Pubmed was developed by the National Center for Biotechnology Information at the U.S. National Institute for Health. It would therefore be an appropriate database to search regarding technology in medicine, nursing, dentistry, veterinary medicine, the health care system, and the preclinical sciences. Pubmed would, however, receive a low relevance score in relation to an application regarding vehicle engines.

Once the database is selected, the search may be run to locate relevant prior art. In one embodiment, prior art may be scored as relevant using simple table based method, quantitative and qualitative approaches to decision analysis, a rules based system, or artificial intelligence techniques, for example neural net, Bayesian algorithm, genetic algorithms, pattern recognition, expert systems, case based reasoning, fuzzy systems, hybrid intelligent systems, evolutionary computation, concept processing or any combination thereof. Such methods may evaluate multiple criteria including common words and phrases in the patent application and the prior art; the class and sub class of the patent application and the prior art; the amount of time the prior art was considered by the end user or patent examiner on the same or similar patent applications; the notes an end user or patent examiner has attached to the prior art; the number of times the prior art has been cited by other publications in the field; the office actions performed by the system or patent examiners utilizing the same prior art on similar patent applications; the patent application data of the patent application and the data of the prior art; the number of examiners and/or end users who have reviewed or cited the prior art for similar patent applications in the past; the seniority, grade, or ranking of patent examiners who have cited the prior art in similar patent applications; the number of times the prior art data is cited in similar patent applications; the number of times the prior art data is accessed by end users and patent examiners to conduct searches on similar patent applications, or any combination thereof. In some embodiments, the search may be run by the submitter or an external service prior to submission of the application to the patent office. In other embodiments, the search may be run prior to assigning the application to an examiner.

In some embodiments, the elements of any particular score may be weighted. In further embodiments, the weighting of the elements may change depending on the use of the score. For example, the weighting may change depending on the information in the application. With relatively new references, the number of examiners and/or end users who have reviewed or cited the prior art may be discarded as irrelevant, or weighted more heavily if a high number of examiners and/or end users have accessed a new reference. In some embodiments, the score of the prior art may be used to determine its relevance. The results may be compiled in a certified prior art search with a ranked listing of the most relevant prior art. Such prior art searches may be supplemented by manual searches performed by an examiner. In some embodiments, a manual search may be performed initially and then supplemented by an automated search.

In some embodiments, prior art searches are performed when an application is received by the patent office. In other embodiments, prior art searches may be performed prior to submission of the application to the patent office. In some embodiments the submitter of the application may be required to provide comments to distinguish the invention over the prior art located whether the prior art is identified before or after submission of the application. In further embodiments, a search is run periodically during the pendency of the application to ensure that all potential references have been found, to ensure that no new art has been entered into the system, and to take into consideration any additional comments or references that have been submitted in reference to the application.

In the event that new prior art is located, the end user can be notified automatically or at the discretion of the examiner. In some embodiments, the end user may be given the opportunity to distinguish the new prior art over the invention prior to receiving a formal rejection. In other embodiments, such commentary may only be provided if an examiner has not yet issued any formal action on the application. Such commentary may be used to refine prior art searches and/or may alter the relevancy scores of the prior art that has already been identified.

In some embodiments, manual searches may be conducted that supplement or add to the search performed by the automated system. References identified in a manual search that have not been identified in an automated search may be added to the automated search providing feedback and a means for refining the algorithms used to perform automated searches.

Artificial intelligence systems or neural nets can acquire the necessary tools to perform prior art searches by any means applicable. In some embodiments, such refinement is acquired by reviewing the search strategies of previously filed applications. File wrappers of previous patent applications including prior search strategies can be examined to develop rules for conducting searches on subsequently submitted applications. In another embodiment, techniques such as crossover and mutation may be used to create a self-improving search tool.

Once an application is filed, it may become prior art for subsequently filed applications. In some embodiments pending applications may be published. In other embodiments, pending applications may be unpublished. Either or both published and unpublished applications may be used as references against a pending application.

When the system determines that an unpublished application is relevant prior art, the end user may be informed that such an application exists. In some embodiments, the end user must rely on the patent examiner to examine the unpublished prior art and notify him if it is an issue for the pending application. In other embodiments, the end user can request that the unpublished application be published. In further embodiments, the end user may request a second examiner compare the unpublished prior art and the currently pending application. In additional embodiments, if unpublished references are used, they could be automatically reviewed by two or more examiners prior to citation in a rejection. In some embodiments, the application and the unpublished reference may be randomly assigned to another examiner in the same art unit. Review by additional examiners may or may not be anonymous. For example, in some embodiments the initial or subsequent examiner may know the identity of the other examiner(s). In other embodiments, the review may be blind. In the event that the review is blind, the examiners may still be able to discuss the application and the unpublished prior art through blind drops, anonymous email, anonymous instant messaging or any other means of communication which would conceal their identities.

In some embodiments, it may be useful to have reviews or comments on prior art. Such comments may be submitted by examiners, end users submitting the references with an application, or third parties. Comments may concern the relation of the references to a particular application, summaries of the references, general observations of the references, or any combination thereof. In some embodiments such comments may be public. In other embodiments, comments may be available to other examiners. In further embodiments, comments may be accessed by the system in determining the relevance of a reference as prior art against a pending application.

In some embodiments, comments may be reviewed by other inventors, researchers, patent attorneys, the general public, and/or examiners who may challenge the application or comments by submitting their own comments. The value of comments and the weight they receive from the system may depend on the submitter. For instance, comments from submitters who have established a track record of insightful submissions may be given more weight than comments from first time submitters. In other embodiments, comments from established practitioners, judges, professors, retired examiners, experts in a particular field, etc. may be given more weight than comments from the general public. The credentials of a particular commentator could be submitted with the comments and verified by the system or obtained independently, for example through a review of databases or other electronic information. In another embodiment, examiners could evaluate the usefulness of any particular comment and such feedback could increase or decrease the weight of the comment from any particular commentator. Feedback may be used to continuously update the system, update it periodically, or may be used as part of a multivariate or regression analysis to alter the way information is processed.

In further embodiments, applications may be submitted to the inventors or authors of relevant prior art for review. The comments provided by other inventors or researchers in the field could be used to distinguish the prior art or as the basis for a rejection in a subsequent action issued by the patent office. In some embodiments, any comments submitted regardless of the source could be weighted. Weighting may depend on the number of applications the inventor has filed, the number of articles authored, the journals in which such articles were published, the value of previously submitted comments, the institution with which the inventor or author is associated, the number of applications the examiner has examined, the seniority of the examiner, the number of cases a judge has tried, the education of the examiner, the education of the inventor, the education of the author, any other variable which may effect the quality of the comments by the inventor, or any combination thereof.

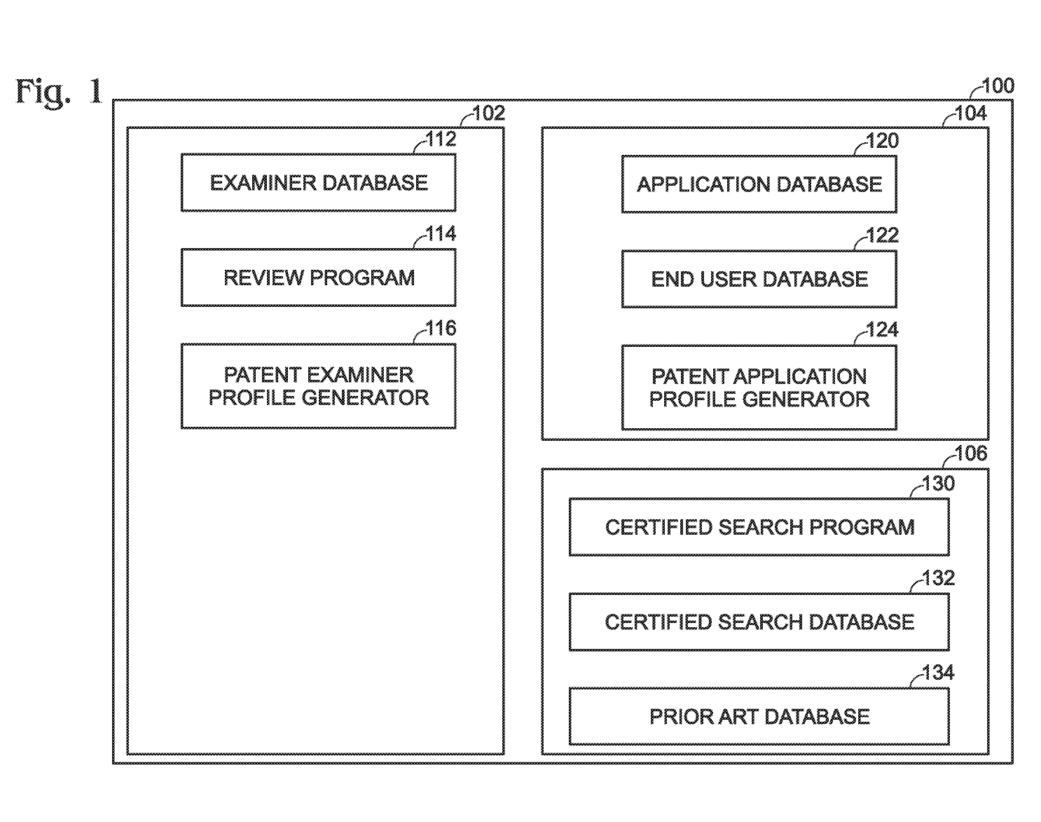

FIG. 1 provides an exemplary system 100 that may be used to provide the embodiment described above. As shown, system 100 may include Examiner server 102, Application server 104 and Search server 106.

Examiner server 102 may include a review program 114, and a patent examiner profile generator 116. Examiner server 102 may additional included databases such as examiner database 112.

Application server 104 may include programs such as patent application profile generator 124 and databases such as application database 120 and end user database 122. Search server 106 may include information such as certified search program 130, as well as various databases such as certified search database 132 and prior art database 134.

Applications for examination, whether initial examination or subsequent review, may be submitted by any means possible. In some embodiments, applications may be submitted electronically. In other embodiments, applications may be submitted on paper. In a further embodiment, applications may be submitted by facsimile.

Information regarding the application received may be stored, for example, in application database 120. Application database 120 may include information such as application ID, application data, certified search ID, distinguishing language data, application class, application subclass, end user ID, file date, application score, application length, and application claims. Such information may be used to compile a profile for the application and a score using, for example, patent application profile generator program 124. A profile score for a patent application may be calculated, for example, using some or all of the following steps:
1. Receive patent application.
2. Generate score for patent application based on patent application data.
3. Store patent application score.

The score for the patent application may be used in selecting the most appropriate database for selecting the most appropriate databases in which to run a search for prior art as well as in making determinations as to the relevance of prior art. Such searches may be performed before or after an application is formally submitted and or assigned to an Examiner.

The search system for identifying prior art may use simple table based method, quantitative and qualitative approaches to decision analysis, a rules based system, or artificial intelligence techniques, for example neural net, Bayesian algorithm, genetic algorithms, pattern recognition, expert systems, case based reasoning, fuzzy systems, hybrid intelligent systems, evolutionary computation, concept processing or any combination thereof. Prior art searches may be run in any database available. In some embodiments, searches may be run in a database such as prior art database 134. Prior art database 134 may include information such as prior art ID, prior art type, prior art date, prior art contents, prior art notes, note taker ID, and prior art note dates.

In some embodiments, the certified search program 130 may be programmed to perform searches using file wrapper data from previously examined applications. Such information may be transmitted using some or all of the following steps:
1. Receive File Wrapper Data.
2. Use File Wrapper Data To Train Genetic Algorithm to Conduct Certified Searches.
   In another embodiment, the results of a prior art search may be improved by inputting the results of a manual search into the program such as certified search program 130. Such improvements may be made using some or all of the following steps:
1. Output Patent Application Data and Certified Search.
2. Receive Additional Prior Art References.
3. Use Additional Prior Art References to Enhance Genetic Algorithm that created Certified Search.

Searches may be run before or after an application is assigned. In one embodiment, search as conducted using a program such as certified search program 130. Such searches may be conducted using some or all of the following steps:
1. Receive Patent Application Data.
2. Retrieve Prior Art.
3. Compare Patent Application Data to Prior Art.
4. Identify Relevant Prior Art Documents.
5. Store Relevant Prior Art Documents with Patent Application and Time Stamp.
   The results of a search may be stored by any means possible. In some embodiments, such information may be stored in certified search database 132. Such a database may include information such as search ID, researcher ID and a list of the prior art references found.

In some embodiments, a search and first office action may be issued prior to the application being assigned to an Examiner. For example, an automated system could process the application, input the relevant information and output a set of relevant prior art documents. The end user may be required to respond or distinguish the application from the prior art identified by the system prior to further processing of the application or review by an examiner though there may also be a means for appeal. In some embodiments, lesser fees may be applied for the initial search. End users may determine not to pursue the application further based on the results of the initial, automated search. In other embodiments, additional fees may be charged to have the application reviewed by a human examiner.

In one embodiment, the results of the search may be given along with the application to the appropriate Examiner. Examiners may be assigned by any means applicable. In some embodiments, profiles of examiners are created and the relevancy of their experience is matched to appropriate applications. Information on particular examiners may be stored, for example in patent examiner database 112. Such a database may include information such as examiner ID, examiner profile, examiner work load, previous examinations, examiner education, examiner experience, examiner training and examiner score, or any combination thereof.

A score for an examiner may be calculated, for example, using patent examiner profile generation program 116. Patent examiner profile generation program 116 may be configured, for example, to use some or all of the following steps:
1. Retrieve patent examiner history.
2. Retrieve patent applications previously examined by examiner.
3. Generate a score for patent examiner based on applications previously examined by examiner and patent examiner history.
4. Store patent examiner score.

The score for an examiner may be compared to the score for an application to determine the most appropriate examiner for a particular application.

The results of the search and or any comments by an examiner are sent to the end user. Information regarding the end user may be stored, for example, in the end user database such as end user database 122. Such a database may include information such as end user ID, end user profile, end user billing information, end user correspondence and end user score.

An end user may respond to the prior art produced by the search as well as any comments by the Examiner. Once a response is received to the first office action, whether generated by the system or by an Examiner, a subsequent search may be run to ensure that all relevant prior art has been found. Particularly in areas of high technology, there may be a lag in the publication of literature and its entry into a database. A refreshing of the search results may be run using, for example, some or all of the following steps:
1. Retrieve Patent Application Data and Certified Search.
2. Compare Patent Application Data to Prior Art Data.
3. Generate list of Relevant Prior Art.
4. Compare list to Certified Search.
5. If list has additional prior art references, store references with Patent Application Data.
6. Output notice to end user that patent application has received additional prior art references.

In the event that new art is found, the first office action may be supplemented or reissued. Such an issuance may be automated or performed by an Examiner using some or all of the following steps:
1. Receive request to review additional prior art.
2. Output Patent Application Data and Additional Prior Art.
3. Receive Additional Distinguishing Language over Additional Prior Art.
4. Store Additional Distinguishing Language with Patent Application and Time Stamp.
5. Determine Fee for filing Additional Distinguishing Language.
6. Apply Fee to End User Account.

In the event that an examiner discovers additional relevant art, or an end user submits art that was not identified in a prior art search, such information may be added to the certified search results. The addition of these documents may further refine the search criteria, adding to its sophistication and accuracy. Such an addition may take place using some or all of the following steps:
1. Output Patent Application Data and Certified Search.
2. Receive Additional Prior Art References.
3. Store Additional Prior Art References as Part of Certified Search and Time Stamp.

In some embodiments, the prior art located may be unpublished. In such an event, the end user may request that the prior art be published in order to be used by the Examiner, and/or a second review of the application and the prior art by an additional examiner may be requested or automatically initiated. For example, such additional examination could be initiated using review program 114. Review program 114 may use some or all of the following steps:
1. Receive Request to Examine Patent Application.
2. Ouput Patent Application, Relevant Prior Art, and Distinguishing Language.
3. Receive Response to Distinguishing Language.
4. Receive Additional Relevant Prior Art.
5. Receive Comments on Additional Prior Art.
6. Store Response to Distinguishing Language, Additional Relevant Prior Art and Comments on Additional Prior Art with Patent Application and Time Stamp.
7. If Additional Prior Art Cited was unpublished, determine a Second Examiner and Place Patent Application in Second Examiner Queue.
8. Output notification to End User that Patent Application is Receiving Second Examination because Additional Prior Art cited by first examiner was unpublished.

In other embodiments, an additional review of unpublished materials cited against an application must be requested by the end user. Such a request must be submitted by the end user. In some embodiments, such a request may trigger some or all of the following steps:
1. Receive request to review Response to First Office Action.
2. Output Patent Application, Response to Distinguishing Language, Additional Relevant Prior Art, and Comments on Additional Prior Art.
3. Receive Request for Reexamination if Additional Prior Art Cited was Unpublished.

Subsequent office actions may follow similar patterns with additional searches or comments from the examiner.

In some embodiments, it may be useful to receive commentary on the prior art as well as the pending application. Such commentary may be supplied by the end user, examiners or third parties. In some embodiments, applications may be published for comment prior to issuance. In other embodiments, examiners who use particular references in rejecting an application may append commentary to the reference such as a summary, the particular relevance of the prior art, or any additional information that may be useful in other searches, or as part of the record of the application being examined. Commentary may also be provided by third parties. Third parties may additionally submit prior art for consideration after reviewing application along with comments regarding its similarity to the prior art. This may be particularly useful in areas of rapidly evolving technology where it may be difficult for an examiner to remain appraised of all of the changes in the art.

Comments may be ranked or weighted depending on the commentator. Such a weighting may depend on the standing of the commentator and/or the usefulness or frequency of previous comments submitted by that commentator. Commentary may be published or unpublished by the central system and may or may not be accessible to the general public.

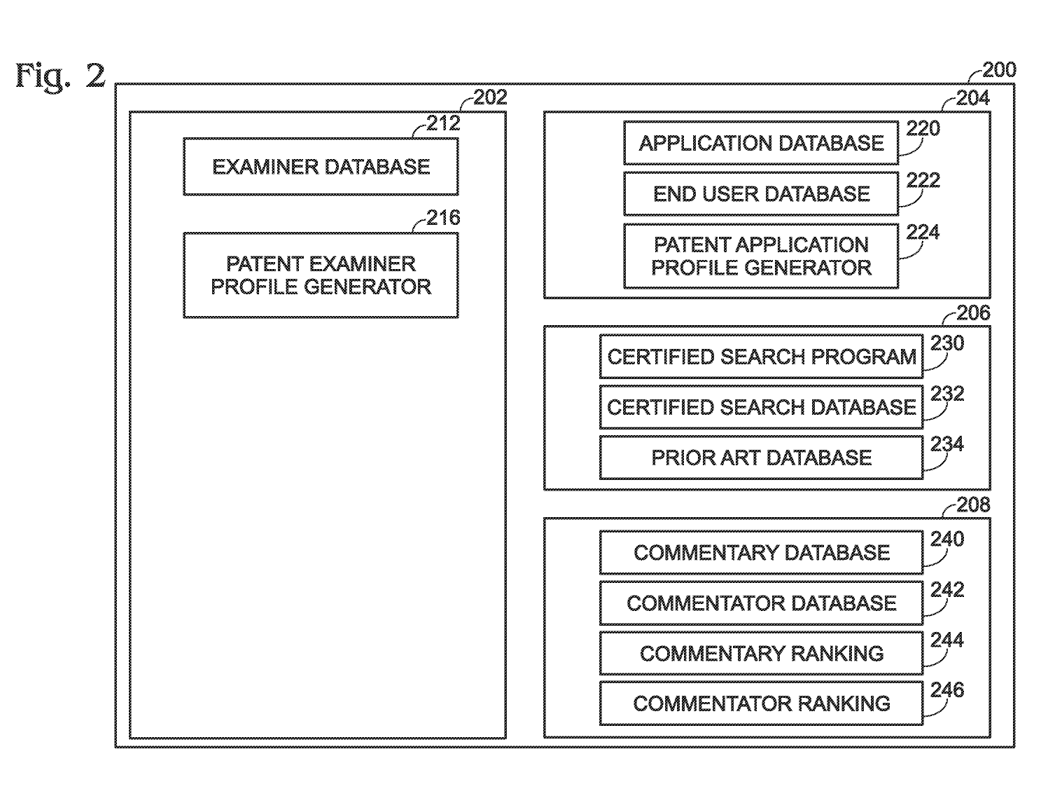

FIG. 2 provides an exemplary system 200 that may be used to provide the embodiment described above. As shown, system 200 may include Examiner server 202, Application server 204, Search server 206 and Commentary server 208.

Examiner server 202 may include a patent examiner profile generator 216. Examiner server 202 may additionally include one or more databases such as Examiner database 212.

Application server 204 may include programs such as application profile generator 224 and databases such as application database 220 and end user database 222.

Search server 206 may include information such as certified search program 230, as well as myriad databases such as certified search database 232 and prior art database 234.

Commentary server 208 may include programs such as commentary ranking 244 and commentator ranking 246 as well as databases such as commentary database 240 and commentator database 242.

Applications for examination, whether initial examination or subsequent review, may be submitted by any means possible. In some embodiments, applications may be submitted electronically. In other embodiments, applications may be submitted on paper. In a further embodiment, applications may be submitted by facsimile.

In some embodiments, applications may be published upon receipt. In other embodiments, applications may remain unpublished until issuance. In the event that applications are published, they may be opened for commentary. Commentary may occur at any point during the application process or may be limited to particular points in the application process. For example, commentary may be submitted just prior to issuance, at the beginning of the application process, after the first office action has been issued, or at any other relevant time period. In some embodiments, commentary may be limited to the claims. In other embodiments, commentary may be limited to the body of the application.

In some embodiments, commentary may be stored in commentary database 240 which may include information such as application or literature commented on, comments, commentator ID, commentator ranking, comment ranking, usefulness of comment, or any other additional information which would increase the usefulness of the comments received. In other embodiments, information regarding the application received including any commentary may be stored, for example, in application database 220. Application database 220 may include information such as application ID, application data, certified search ID, distinguishing language data, application class, application subclass, end user ID, file date, application score, application length, commentary and application claims. Such information may be used to compile a profile for the application and a score using, for example, patent application profile generator program 224. A profile score for a patent application may be calculated, for example, using some or all of the following steps:
1. Receive patent application.
2. Generate score for patent application based on patent application data.
3. Store patent application score.

In some embodiments, the application may be sent out for commentary. The score of the patent application may be used in determining the most appropriate expert or experts to whom the application should be submitted for review. Such experts may volunteer, be elected or appointed to such positions. In some embodiments, such positions may be paid.

Information regarding commentators may be stored by any means applicable. For example, information may be stored in commentator database 242. Commentator database 242 may include information such as commentator ID, education, experience, inventions, publications, employer, applications filed, applications reviewed, usefulness of previous comments, current research, ranking, or any combination thereof.

Commentators and or their comments may receive a ranking. For example, such a ranking may be based on commentator education, experience, inventions, publications, employer, applications filed, applications reviewed, usefulness of previous comments, current research, number of previous comments, accuracy of previous comments, or any combination thereof. Such information may be used to score the usefulness of a particular comment or comments from a particular commentator using commentary ranking program 244 and commentator ranking program 246.

In other embodiments, commentators may be able to submit prior art which may be useful in determining the patentability of the invention. Such information may or may not be reviewed by an examiner for usefulness. The prior art may be stored, for example in prior art database 234 and tagged to be connected with the application. In some embodiments, the end user may be required to distinguish the prior art submitted by the commentator. In other embodiments, the identified prior art may be used to refine search algorithms for prior art searches.

The score for the patent application may additionally be used to select the most appropriate database for selecting the most appropriate databases in which to run a search for prior art as well as in making determinations as to the relevance of prior art. Such searches may be performed before or after an application is formally submitted and or assigned to an Examiner.

The search system for identifying prior art may use simple table based method, quantitative and qualitative approaches to decision analysis, a rules based system, or artificial intelligence techniques, for example neural net, Bayesian algorithm, genetic algorithms, pattern recognition, expert systems, case based reasoning, fuzzy systems, hybrid intelligent systems, evolutionary computation, concept processing or any combination thereof. Prior art searches may be run in any database available. In some embodiments, searches may be run in a database such as prior art database 234. Prior art database 234 may include information such as prior art ID, prior art type, prior art date, prior art contents, prior art notes, note taker ID, and prior art note dates.

In some embodiments, the certified search program 230 may be programmed to perform searches using file wrapper data from previously examined applications. Such information may be transmitted using some or all of the following steps:
1. Receive File Wrapper Data.
2. Use File Wrapper Data To Train Genetic Algorithm to Conduct Certified Searches.
   In another embodiment, the results of a prior art search may be improved by inputting the results of a manual search, commentary, or third party submissions into a program such as certified search program 230. Such improvements may be made using some or all of the following steps:
1. Output Patent Application Data and Certified Search.
2. Receive Additional Prior Art References and/or comments.
3. Use Additional Prior Art References to Enhance Genetic Algorithm that created Certified Search.

Searches may be run before or after an application is assigned. In one embodiment, search as conducted using a program such as certified search program 230. Such searches may be conducted using some or all of the following steps:
1. Receive Patent Application Data.
2. Retrieve Prior Art.
3. Compare Patent Application Data to Prior Art.
4. Identify Relevant Prior Art Documents.
5. Store Relevant Prior Art Documents with Patent Application and Time Stamp.
   The results of a search may be stored by any means possible. In some embodiments, such information may be stored in certified search database 232. Such a database may include information such as search ID, researcher ID, commentator ID, examiner ID and a list of the prior art references found.

In some embodiments, a search and first office action may be issued prior to the application being assigned to an Examiner. For example, an automated system could process the application, input the relevant information and output a set of relevant prior art documents. The prior art documents could be supplemented by information or comments from commentators. The end user may be required to respond or distinguish the application from the prior art identified by the system and respond to the commentator's comments prior to further processing of the application or review by an examiner though there may also be a means for appeal. In some embodiments, lesser fees may be applied for the initial search. End users may determine not to pursue the application further based on the results of the initial, automated search and/or based on the information received from commentators. In other embodiments, additional fees may be charged to have the application reviewed by a human examiner.

In other embodiments, the results of the search may be given along with the application to the appropriate Examiner. Examiners may be assigned by any means applicable. In some embodiments, profiles of examiners are created and the relevancy of their experience is matched to appropriate applications. Information on particular examiners may be stored, for example in patent examiner database 212. Such a database may include information such as examiner ID, examiner profile, examiner work load, previous examinations, examiner education, examiner experience, examiner training and examiner score, or any combination thereof.

A score for an examiner may be calculated, for example, using patent examiner profile generation program 216. Patent examiner profile generation program 216 may be configured, for example, to use some or all of the following steps:
1. Retrieve patent examiner history.
2. Retrieve patent applications previously examined by examiner.
3. Generate a score for patent examiner based on applications previously examined by examiner and patent examiner history.
4. Store patent examiner score.

The score for an examiner may be compared to the score for an application to determine the most appropriate examiner for a particular application.

The results of the search and or any comments by an examiner or third party are sent to the end user. Information regarding the end user may be stored, for example, in the end user database such as end user database 222. Such a database may include information such as end user ID, end user profile, end user billing information and end user score.

An end user may respond to the prior art produced by the search as well as any comments by the Examiner and/or commentator. Once a response is received to the first office action, whether generated by the system or by an Examiner, a subsequent search may be run to ensure that all relevant prior art has been found. Particularly in areas of high technology, there may be a lag in the publication of literature and its entry into a database. A refreshing of the search results may be run using, for example, some or all of the following steps:
1. Retrieve Patent Application Data and Certified Search.
2. Compare Patent Application Data to Prior Art Data.
3. Generate list of Relevant Prior Art.
4. Compare list to Certified Search.
5. If list has additional prior art references, store references with Patent Application Data.
6. Output notice to end user that patent application has received additional prior art references.

In other embodiments, an initial search may be run prior to publication. In such an event, once the end user has responded to the initial search, an application may be opened for commentary. Such commentary may be used to supplement the search and may include additional prior art submitted by commentators. In the event that new art is found, the first office action may be supplemented or reissued. Such an issuance may be automated or performed by an Examiner using some or all of the following steps:
1. Receive request to review additional prior art.
2. Output Patent Application Data and Additional Prior Art.
3. Receive Additional Distinguishing Language over Additional Prior Art.
4. Store Additional Distinguishing Language with Patent Application and Time Stamp.
5. Determine Fee for filing Additional Distinguishing Language.
6. Apply Fee to End User Account.

In the event that an examiner or commentator discovers additional relevant art, or an end user submits art that was not identified in a prior art search, such information may be added to the certified search results. The addition of these documents may further refine the search criteria, adding to its sophistication and accuracy. Such an addition may take place using some or all of the following steps:
1. Output Patent Application Data and Certified Search.
2. Receive Additional Prior Art References.
3. Store Additional Prior Art References as Part of Certified Search and Time Stamp.

The responses of the end user may overcome the prior art or may result in the generation of a second Office action. A second Office action may be drafted by the preliminary examiner or by a subsequent examiner. A second Office action may be generated using some or all of the following steps:
1. Receive Request to Examine Patent Application.
2. Ouput Patent Application, Relevant Prior Art, and Distinguishing Language.
3. Receive Response to Distinguishing Language.
4. Receive Additional Relevant Prior Art.
5. Receive Comments on Additional Prior Art.
6. Store Response to Distinguishing Language, Additional Relevant Prior Art and Comments on Additional Prior Art with Patent Application and Time Stamp.

Any subsequent office actions or reviews may follow similar steps.

It will be appreciated that while, for the sake of discussion, various databases have been described separately, the data in these and any other suitable databases could be merged into a single large databases and/or maintained separately in additional databases, or in other structures besides a database. Moreover, any such databases could be independent or linked, and the data in these databases could be stored centrally on a server or separately on game devices.

The present disclosure provides numerous systems and methods related to examination systems for real world patent systems as well as patent systems in virtual environments in online computer games. It should be appreciated that numerous embodiments are described in detail and that various combinations and subcombinations of these embodiments are contemplated by the present disclosure.

Of course it will be appreciated that the systems methods described herein are provided for the purposes of example only and that none of the above systems methods should be interpreted as necessarily requiring any of the disclosed components or steps nor should they be interpreted as necessarily excluding any additional components or steps. Furthermore, it will be understood that while various embodiments are described, such embodiments should not be interpreted as being exclusive of the inclusion of other embodiments or parts of other embodiments.

The invention is described with reference to several embodiments. However, the invention is not limited to the embodiments disclosed, and those of ordinary skill in the art will recognize that the invention is readily applicable to many other diverse embodiments and applications as are reflected in the range of real world financial institutions, instruments and activities. Accordingly, the subject matter of the present disclosure includes all novel and nonobvious combinations and subcombinations of the various systems, methods configurations, embodiments, features, functions, and/or properties disclosed herein.

A reference to “another embodiment” in describing an embodiment does not necessarily imply that the referenced embodiment is mutually exclusive with another embodiment (e.g., an embodiment described before the referenced embodiment), unless expressly specified otherwise.

The terms “include”, “includes”, “including”, “comprising” and variations thereof mean “including but not limited to”, unless expressly specified otherwise.

The term “consisting of” and variations thereof includes “including and limited to”, unless expressly specified otherwise. The terms “a”, “an” and “the” mean “one or more”, unless expressly specified otherwise.

The term “plurality” means “two or more”, unless expressly specified otherwise.

The term “herein” means “in this patent application, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase “at least one of a widget, a car and a wheel” means either (i) a widget, (ii) a car, (iii) a wheel, (iv) a widget and a car, (v) a widget and a wheel, (vi) a car and a wheel, or (vii) a widget, a car and a wheel.

The phrase “based on” does not mean “based only on”, unless expressly specified otherwise. In other words, the phrase “based on” describes both “based only on” and “based at least on”.

The term “represent” and like terms are not exclusive, unless expressly specified otherwise. For example, the term “represents” does not mean “represents only”, unless expressly specified otherwise. In other words, the phrase “the data represents a credit card number” describes both “the data represents only a credit card number” and “the data represents a credit card number and the data also represents something else”.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The terms “such as”, “e.g.” and like terms means “for example”, and thus does not limit the term or phrase it explains. For example, in the sentence “the computer sends data (e.g., instructions, a data structure) over the Internet”, the term “e.g.” explains that “instructions” are an example of “data”that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “determining” and grammatical variants thereof (e.g., to determine a price, determining a value, determine an object which meets a certain criterion) is used in an extremely broad sense. The term “determining” encompasses a wide variety of actions and therefore “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing, and the like. It does not imply certainty or absolute precision, and does not imply that mathematical processing, numerical methods or an algorithm process be used. Therefore “determining” can include estimating, predicting, guessing and the like.

It will be readily apparent to one of ordinary skill in the art that the various processes described herein may be implemented by, e.g., appropriately programmed general purpose computers and computing devices. Typically a processor (e.g., one or more microprocessors, one or more microcontrollers, one or more digital signal processors) will receive instructions (e.g., from a memory or like device), and execute those instructions, thereby performing one or more processes defined by those instructions.

A “processor” may include one or more microprocessors, central processing units (CPUs), computing devices, microcontrollers, digital signal processors, or like devices or any combination thereof. Thus a description of a process is likewise a description of an apparatus for performing the process. The apparatus can include, e.g., a processor and those input devices and output devices that are appropriate to perform the method. Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software only.

The term “computer-readable medium” includes any medium that participates in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), SAP, ATP, Bluetooth™, and TCP/IP, TDMA, CDMA, and 3G; and/or (iv) encrypted to ensure privacy or prevent fraud in any of a variety of ways well known in the art.

Thus a description of a process is likewise a description of a computer-readable medium storing a program for performing the process. The computer-readable medium can store (in any appropriate format) those program elements which are appropriate to perform the method.

Just as the description of various steps in a process does not indicate that all the described steps are required, embodiments of an apparatus include a computer/computing device operable to perform some (but not necessarily all) of the described process.

Likewise, just as the description of various steps in a process does not indicate that all the described steps are required, embodiments of a computer-readable medium storing a program or data structure include a computer-readable medium storing a program that, when executed, can cause a processor to perform some (but not necessarily all) of the described process.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) are well known and could be used to store and manipulate the data types described herein. Likewise, object methods or behaviors of a database can be used to implement various processes, such as the described herein. In addition, the databases may, in a known manner, be stored locally or remotely from any device(s) which access data in the database.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, or a combination of any of the above). Each of the devices may themselves comprise computers or other computing devices, such as those based on the Intel® Pentium® or Centrino™ processor, that are adapted to communicate with the computer. Any number and type of devices may be in communication with the computer.

In an embodiment, a server computer or centralized authority may not be necessary or desirable. For example, the present invention may, in an embodiment, be practiced on one or more devices without a central authority. In such an embodiment, any functions described herein as performed by the server computer or data described as stored on the server computer may instead be performed by or stored on one or more such devices.

Those having skill in the art will recognize that there is little distinction between hardware and software implementations. The use of hardware or software is generally a choice of convenience or design based on the relative importance of speed, accuracy, flexibility and predictability. There are therefore various vehicles by which processes and/or systems described herein can be effected (e.g., hardware, software, and/or firmware) and that the preferred vehicle will vary with the context in which the technologies are deployed.

At least a portion of the devices and/or processes described herein can be integrated into a data processing system with a reasonable amount of experimentation. Those having skill in the art will recognize that a typical data processing system generally includes one or more of a system unit housing, a video display device, memory, processors, operating systems, drivers, graphical user interfaces, and application programs, interaction devices such as a touch pad or screen, and/or control systems including feedback loops and control motors. A typical data processing system may be implemented utilizing any suitable commercially available components to create the environment described herein.

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

Each claim in a set of claims has a different scope. Therefore, for example, where a limitation is explicitly recited in a dependent claim, but not explicitly recited in any claim from which the dependent claim depends (directly or indirectly), that limitation is not to be read into any claim from which the dependent claim depends.

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device or article is described herein, more than one device/article (whether or not they cooperate) may alternatively be used in place of the single device/article that is described. Accordingly, the functionality that is described as being possessed by a device may alternatively be possessed by more than one device/article (whether or not they cooperate).

Similarly, where more than one device or article is described herein (whether or not they cooperate), a single device/article may alternatively be used in place of the more than one device or article that is described. For example, a plurality of computer-based devices may be substituted with a single computer-based device. Accordingly, the various functionality that is described as being possessed by more than one device or article may alternatively be possessed by a single device/article.

The functionality and/or the features of a single device that is described may be alternatively embodied by one or more other devices which are described but are not explicitly described as having such functionality/features. Thus, other embodiments need not include the described device itself, but rather can include the one or more other devices which would, in those other embodiments, have such functionality/features.

Numerous embodiments are described in this patent application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments of the invention nor a listing of features of the invention which must be present in all embodiments.

Neither the Title (set forth at the beginning of the first page of this patent application) nor the Abstract (set forth at the end of this patent application) is to be taken as limiting in any way as the scope of the disclosed invention(s). An Abstract has been included in this application merely because an Abstract of not more than 150 words is required under 37 C.F.R. § 1.72(b).

The title of this patent application and headings of sections provided in this patent application are for convenience only, and are not to be taken as limiting the disclosure in any way.

Devices that are described as in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for long period of time (e.g. weeks at a time). In addition, devices that are in communication with each other may communicate directly or indirectly through one or more intermediaries.

A description of an embodiment with several components or features does not imply that all or even any of such components/features are required. On the contrary, a variety of optional components are described to illustrate the wide variety of possible embodiments of the present invention(s). Unless otherwise specified explicitly, no component/feature is essential or required.

Although process steps, algorithms or the like may be described in a sequential order, such processes may be configured to work in different orders. In other words, any sequence or order of steps that may be explicitly described does not necessarily indicate a requirement that the steps be performed in that order. On the contrary, the steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not imply that all or any of the steps are essential or required. Various other embodiments within the scope of the described invention(s) include other processes that omit some or all of the described steps. Unless otherwise specified explicitly, no step is essential or required.

Although a product may be described as including a plurality of components, aspects, qualities, characteristics and/or features, that does not indicate that all of the plurality are essential or required. Various other embodiments within the scope of the described invention(s) include other products that omit some or all of the described plurality.

Unless expressly specified otherwise, an enumerated list of items (which may or may not be numbered) does not imply that any or all of the items are mutually exclusive. Therefore it is possible, but not necessarily true, that something can be considered to be, or fit the definition of, two or more of the items in an enumerated list. Also, an item in the enumerated list can be a subset (a specific type of) of another item in the enumerated list. For example, the enumerated list “a computer, a laptop, a PDA” does not imply that any or all of the three items of that list are mutually exclusive—e.g., an item can be both a laptop and a computer, and a “laptop” can be a subset of (a specific type of) a “computer”.

Likewise, unless expressly specified otherwise, an enumerated list of items (which may or may not be numbered) does not imply that any or all of the items are collectively exhaustive or otherwise comprehensive of any category. For example, the enumerated list “a computer, a laptop, a PDA” does not imply that any or all of the three items of that list are comprehensive of any category.

Further, an enumerated listing of items does not imply that the items are ordered in any manner according to the order in which they are enumerated.

In a claim, a limitation of the claim which includes the phrase “means for” or the phrase “step for” means that 35 U.S.C. § 112, paragraph 6, applies to that limitation.

In a claim, a limitation of the claim which does not include the phrase “means for” or the phrase “step for” means that 35 U.S.C. § 112, paragraph 6 does not apply to that limitation, regardless of whether that limitation recites a function without recitation of structure, material or acts for performing that function. For example, in a claim, the mere use of the phrase “step of” or the phrase “steps of” in referring to one or more steps of the claim or of another claim does not mean that 35 U.S.C. § 112, paragraph 6, applies to that step(s).

With respect to a means or a step for performing a specified function in accordance with 35 U.S.C. § 112, paragraph 6, the corresponding structure, material or acts described in the specification, and equivalents thereof, may perform additional functions as well as the specified function.

Computers, processors, computing devices and like products are structures that can perform a wide variety of functions. Such products can be operable to perform a specified function by executing one or more programs, such as a program stored in a memory device of that product or in a memory device which that product accesses. Unless expressly specified otherwise, such a program need not be based on any particular algorithm, such as any particular algorithm that might be disclosed in this patent application. It is well known to one of ordinary skill in the art that a specified function may be implemented via different algorithms, and any of a number of different algorithms would be a mere design choice for carrying out the specified function.

Therefore, with respect to a means or a step for performing a specified function in accordance with 35 U.S.C. § 112, paragraph 6, structure corresponding to a specified function includes any product programmed to perform the specified function. Such structure includes programmed products which perform the function, regardless of whether such product is programmed with (i) a disclosed algorithm for performing the function, (ii) an algorithm that is similar to a disclosed algorithm, or (iii) a different algorithm for performing the function.

The present disclosure provides, to one of ordinary skill in the art, an enabling description of several embodiments and/or inventions. Some of these embodiments and/or inventions may not be claimed in this patent application, but may nevertheless be claimed in one or more continuing applications that claim the benefit of priority of this patent application. Applicants intend to file additional applications to pursue patents for subject matter that has been disclosed and enabled but not claimed in this patent application.

We claim:

1. A method of performing a prior art search on an application comprising:
a. determining a profile for an application;
b. comparing the profile for an application with the profile for a database;
c. performing a search of prior art in the most relevant database;
d. scoring the relevance of the prior art; and
e. ranking the prior art based on relevance.

2. The method of claim 1, wherein a profile of an application comprises the field of invention, class, subclass, abstract, and claims.

3. The method of claim 2, wherein the profile is converted to a numeric score.

4. The method of claim 1, wherein the search is performed prior to submission of the application to a patent office.

5. The method of claim 4, wherein an end user must distinguish the relevant prior art from the application when the application is submitted to the patent office.

6. The method of claim 1, wherein the search is performed after submission of the application to a patent office.

7. The method of claim 1, wherein the database may contain published or unpublished art.

8. The method of claim 1, wherein the profile of a database comprises the contents of particular databases, the accuracy of particular databases, how current particular databases are, and the number of times other examiners have used particular databases.

9. The method of claim 8, wherein the profile is converted to a numerical score.

10. The method of claim 1, wherein the relevance of the prior art may be determined by comparing one or more criteria comprising common words and phrases, the class and sub class of the patent application and the prior art, the amount of time the prior art was considered by the end user or patent examiner on the same or similar patent applications, the notes an end user or patent examiner has attached to the prior art, the office actions performed by the system or patent examiners utilizing the same prior art on similar patent applications, the number of times the prior art has been cited, the seniority of the examiners who have cited the prior art for similar applications in the past, or the number of times the prior art data has been accessed in similar searches.

11. The method of claim 10, wherein the criteria may be weighted.

12. A method of increasing the review of an application comprising:
a. publishing an application for comment;
b. receiving commentary from third parties; and
c. evaluating the commentary for relevance.

13. The method of claim 12, wherein the commentary is weighted.

14. The method of claim 13, wherein the weight of commentary is based on one or more criteria comprising the number of times the commentator has submitted the comments, the usefulness of previous comments, the number of publications the commentator has, or the credentials of the commentator.

15. The method of claim 12, wherein the commentary is available to the public.

16. The method of claim 12, wherein the commentary is available to examiners.

17. A method of increasing the accuracy of a search of prior art comprising:
a. determining a profile for a patent application;
b. inputting references cited in the application;
c. inputting references cited in an information disclosure statement;
d. reviewing the search strategy used for previous applications with similar profiles; and
e. initiating a search based on the information in the search strategy used for previous applications with similar profiles cross-referenced with references cited in the application.

18. The method of claim 17, further comprising the inputting of references discovered by an examiner in a manual search.

19. The method of claim 17, wherein the search technique is self improving.

20. The method of claim 17, wherein the search can be performed using artificial intelligence, table based method, a rules based system, neural net, Bayesian algorithm, genetic algorithms, pattern recognition, expert systems, case based reasoning, fuzzy systems, hybrid intelligent systems, evolutionary computation, or concept processing.
